(19) United States
(12) Patent Application Publication
(10) Pub. No.: US 2019/0189069 A1
(43) Pub. Date: Jun. 20, 2019

(54) DRIVING METHOD AND DRIVING APPARATUS OF DISPLAY PANEL, AND DISPLAY APPARATUS

(71) Applicant: HKC Corporation Limited, Shenzhen City (CN)

(72) Inventor: Bei Zhou Huang, Shenzhen City (CN)

(21) Appl. No.: 16/158,668

(22) Filed: Oct. 12, 2018

Related U.S. Application Data
(63) Continuation of application No. PCT/CN2018/097930, filed on Aug. 1, 2018.

(30) Foreign Application Priority Data
Dec. 18, 2017 (CN) 201711368982.X

(51) Int. Cl. G09G 3/36

(52) U.S. Cl. CPC G09G 3/3614; G09G 2300/0452; G09G 3/3607; G09G 3/3688

(57) ABSTRACT

A driving method and a driving apparatus of a display panel and a display apparatus are provided. The driving method includes: dividing multiple sub-pixels of a display panel into several sub-pixel groups, to make each of the sub-pixel groups include adjacent two columns of the sub-pixels; using drive voltages of opposite polarities to drive the sub-pixels in each adjacent two of the sub-pixel groups; and using drive voltages of different voltage levels to drive the sub-pixels of a first pixel unit and the sub-pixels of a second pixel unit. The first pixel unit and the second pixel unit are adjacently disposed in the display panel.

### FIELD OF THE DISCLOSURE

The disclosure relates to the field of display technology, and more particularly to a driving method of a display panel, a driving apparatus of a display panel and a display apparatus.

### BACKGROUND

In an exemplary vertical alignment (VA) liquid crystal display device, during displaying an image, liquid crystal molecules maintain certain deflection angles so that light transmittances at different viewing angles are different, which would cause the user to feel a color shift phenomenon that colors of an image observed at different viewing angles are different.

In order to improve the color shift, it is a common practice to divide each of pixel electrodes of RGB sub-pixels in each pixel unit into two independent pixel electrodes and apply different drive voltages onto the two pixel electrodes to improve the color shift. In this method, as the number of the pixel electrodes increases, more metal wires or TFT (thin film transistor) elements are additionally required for driving the display panel. Moreover, since the metal wires and the TFT elements are opaque, the method would sacrifice the light-transmissive aperture area, affect the transmittance of panel and increase the backlight cost.

In order to avoid the increase of metal wires or TFT elements, another method is to apply two high and low different drive voltage signals respectively onto each adjacent two pixel units. Specifically, at the same time, every adjacent two sub-pixels are applied with drive voltages of different polarities. In this way, positive and negative polarities of high voltages of a same row of sub-pixels are mismatched, i.e., the number of sub-pixels with positive high voltages is inconsistent with the number of the sub-pixels with negative high voltages in the same row. As such, due to the influence of parasitic capacitance, in each row, when the number of sub-pixels with positive high voltages is greater than the number of sub-pixels with negative high voltages, an equivalent voltage of a common voltage Vcom is increased with respect to the original Vcom, so that actually charged charges of the sub-pixels with positive high voltages decrease and their luminances decrease correspondingly; on the contrary, actually charged charges of the sub-pixels with negative high voltage increase and their luminances increase correspondingly. Display color and quality would be affected and abnormal image output would be induced.

### SUMMARY

Accordingly, it is necessary to provide a driving method of a display panel, a driving apparatus of a display panel and a display apparatus, so as to prevent the Vcom voltage from being interfered, ensure the correctness of the image signal and improve the picture display quality.

A driving method of a display panel includes: dividing multiple sub-pixels of a display panel into several sub-pixel groups, wherein each of the sub-pixel groups includes adjacent two columns of sub-pixels; using drive voltages of opposite polarities to drive sub-pixels in each adjacent two of the sub-pixel groups; and using drive voltages of different voltage levels to drive sub-pixels of a first pixel unit and sub-pixels of a second pixel unit. The first pixel unit and the second pixel unit are adjacently disposed in the display panel.

In an embodiment, the driving method further includes: in each adjacent two frame display periods, using drive voltages of opposite polarities to drive a same sub-pixel.

In an embodiment, the driving method further includes: in each frame display period, using drive voltages of a same polarity to drive sub-pixels in a same sub-pixel group.

In an embodiment, the step of using drive voltages of different voltage levels to drive sub-pixels of a first pixel unit and sub-pixels of a second pixel unit includes: using first drive voltages of opposite polarities to drive sub-pixels of the first pixel unit respectively located in different sub-pixel groups; and using second drive voltages of opposite polarities to drive sub-pixels of the second pixel unit respectively located in different sub-pixel groups. A voltage level of the first drive voltages is a preset first voltage level, and a voltage level of the second drive voltages is a preset second voltage level.

In an embodiment, the step of using first drive voltages of opposite polarities to drive sub-pixels of the first pixel unit respectively located in different sub-pixel groups includes: using the first drive voltage of positive polarity and the first drive voltage of negative polarity to respectively drive the sub-pixels of the first pixel unit respectively located in different sub-pixel groups; and the step of using second drive voltages of opposite polarities to drive sub-pixels of the second pixel unit respectively located in different sub-pixel groups includes: using the second drive voltage of positive polarity and the second drive voltage of negative polarity to respectively drive the sub-pixels of the second pixel unit respectively located in different sub-pixel groups.

A driving apparatus of a display panel includes: a grouping module, configured to divide multiple sub-pixels of a display panel into several sub-pixel groups, wherein each of the sub-pixel groups includes adjacent two columns of sub-pixels; a first driving module, configured to use drive voltages of opposite polarities to drive sub-pixels in each adjacent two of the sub-pixel groups; and a second driving module, configured to use drive voltages of different voltage levels to drive sub-pixels of a first pixel unit and sub-pixels of a second pixel unit. The first pixel unit and the second pixel unit are adjacently disposed in the display panel.

In an embodiment, the driving apparatus further includes: a third driving module, configured to use drive voltages of opposite polarities to drive a same sub-pixel, in each adjacent two frame display periods.

In an embodiment, the driving apparatus further includes: a fourth driving module, configured to use drive voltages of a same polarity to drive sub-pixels in a same sub-pixel group, in each frame display period.

In an embodiment, the second driving module includes: a first driving unit, configured to use first drive voltages of opposite polarities to drive sub-pixels of the first pixel unit respectively located in different sub-pixel groups; and a second driving unit, configured to use second drive voltages of opposite polarities to drive sub-pixels of the second pixel unit respectively located in different sub-pixel groups. A voltage level of the first drive voltages is a preset first voltage level, and a voltage level of the second drive voltages is a preset second voltage level.

A display apparatus includes a display panel and a driving apparatus of a display panel as that of any one of above embodiments.

The above described driving method and driving apparatus of a display panel and the above described display apparatus can make that in each row, the number of sub-pixels applied with drive voltages of positive high voltage level is equal to the number of sub-pixels applied with drive voltages of negative high voltage level, so that the voltage Vcom is prevented from the impact of parasitic capacitance and thereby correctness of image signal is ensured and the occurrence of color shift or abnormal image quality is avoided.

### BRIEF DESCRIPTION OF THE DRAWINGS

FIG. 1 is a flow chart of a driving method of a display panel of an embodiment.

FIG. 2 is a schematic view of drive voltages of multiple pixel units in a display panel of an embodiment.

FIG. 3 is a schematic view of drive voltages of sub-pixels of multiple pixel units in a display panel of an embodiment.

FIG. 4 is a schematic view of drive voltages of sub-pixels of multiple pixel units in a display panel of another embodiment.

FIG. 5a is a schematic view of drive voltages of multiple pixel units when a display panel displays a particular image according to an embodiment.

FIG. 5b is a schematic view of drive voltages of multiple pixel units when a display panel displays another particular image according to an embodiment.

FIG. 5c is a schematic view of drive voltages of multiple pixel units when a display panel displays still another particular image according to an embodiment.

FIG. 5d is a schematic view of drive voltages of multiple pixel units when a display panel displays even still another particular image according to an embodiment.

FIG. 5e is a schematic view of drive voltages of multiple pixel units when a display panel displays further another particular image according to an embodiment.

FIG. 5f is a schematic view of drive voltages of multiple pixel units when a display panel displays still further another particular image according to an embodiment.

FIG. 5g is a schematic view of drive voltages of multiple pixel units when a display panel displays even still further another particular image according to an embodiment.

FIG. 5h is a schematic view of drive voltages of multiple pixel units when a display panel displays even further another particular image according to an embodiment.

FIG. 6 is a schematic structural view of a driving apparatus of a display panel of an embodiment.

FIG. 7 is a schematic structural view of a display apparatus of an embodiment.

### DETAILED DESCRIPTION OF EMBODIMENTS

In order to facilitate understanding of the disclosure, the disclosure will be described more fully hereinafter with reference to the accompanying drawings. Preferred embodiments of the disclosure are given in the drawings. However, the disclosure may be embodied in many different forms and is not limited to the embodiments described herein. Rather, the embodiments are provided are provided with the purpose of providing a more thorough and comprehensive understanding of the disclosed content of the disclosure.

Unless otherwise defined, all technical and scientific terms used herein have the same meaning as commonly understood by those skilled in the art to which the disclosure pertains. The terminologies used herein in the specification of the disclosure are merely for the purpose of describing specific embodiments, and are not intended to limit the disclosure. The term “and/or” as used herein includes any and all of combinations of one or more related listed items.

For example, a driving method of a display panel includes: dividing multiple sub-pixels of a display panel into several sub-pixel groups, to make each of the sub-pixel groups include adjacent two columns of sub-pixels; using drive voltages of opposite polarities to drive sub-pixels in each adjacent two of the sub-pixel groups; and using drive voltages of different voltage levels to respectively drive each sub-pixel of a first pixel unit and each sub-pixel of a second pixel unit. The first pixel unit and the second pixel unit are adjacently disposed in the display panel.

For example, a driving apparatus of a display panel includes: a grouping module, configured for dividing multiple sub-pixels of a display panel into several sub-pixel groups, to make each of the sub-pixel groups include adjacent two columns of sub-pixels; a first driving module, configured for using drive voltages of opposite polarities to drive sub-pixels in each adjacent two of the sub-pixel groups; and a second driving module, configured for using drive voltages of different voltage levels to respectively drive each sub-pixel of a first pixel unit and each sub-pixel of a second pixel unit. The first pixel unit and the second pixel unit are adjacently disposed in the display panel.

For example, a display apparatus includes a display panel and a driving apparatus of a display panel as that of any one of the above embodiments. For example, the display panel includes several first pixel units and several second pixel units arranged in an array. The first pixel units and the second pixel units are adjacently disposed, and each pixel unit includes multiple sub-pixels.

In order to further understand the above mentioned driving method and driving apparatus of a display panel and the above mentioned display apparatus, descriptions with reference to the drawings will be given in the following.

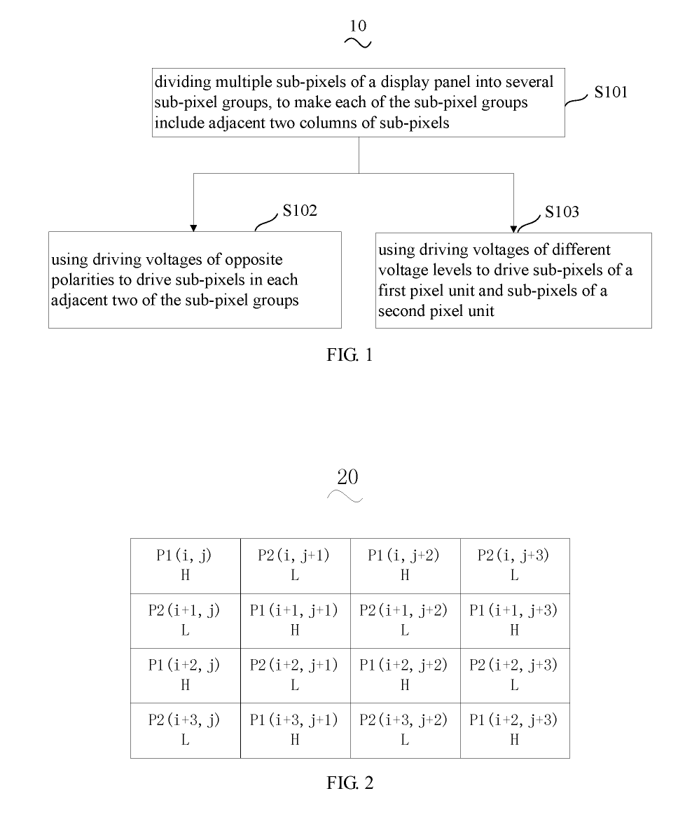

Referring to FIG. 1 through FIG. 3, FIG. 1 is a flow chart of a driving method of a display panel according to an embodiment of the disclosure. The driving method is applied into a display panel. As shown in FIG. 1, the driving method 10 of a display panel includes following steps:

S101: dividing multiple sub-pixels of the display panel into several sub-pixel groups, to make each of the sub-pixel groups include adjacent two columns of sub-pixels;

S102: using drive voltages of opposite polarities to drive sub-pixels in each adjacent two of the sub-pixel groups;

S103: using drive voltages of different voltage levels to drive sub-pixels of a first pixel unit and sub-pixels of a second pixel unit.

In an actual application, the step S102 and the step S103 may be carried out simultaneously. For example, in a same frame display period, sub-pixels of the display panel are applied with drive voltages, to make the drive voltages of the sub-pixels in each adjacent two sub-pixel groups have opposite polarities, and make the drive voltages of each sub-pixel in the first pixel unit and each sub-pixel in the second pixel unit have different voltage levels.

As shown in FIG. 2, the display panel 20 has multiple pixel units arranged in an array. The multiple pixel units include several first pixel units P1 and several second pixel units P2. The first pixel units and the second pixel units are adjacently disposed, or the first pixel units and the second pixel units are alternately arranged. In particular, each pixel unit includes multiple sub-pixels, for example each pixel unit includes multiple sub-pixels of different colors, or each pixel unit includes three kinds of sub-pixels respectively being a red sub-pixel R, a green sub-pixel G and a blue sub-pixel B. (i, j) represents ith row jth column, (i, j+1) represents ith row (j+1)th column, (i+1, j) represents (i+1)th row jth column, and so on.

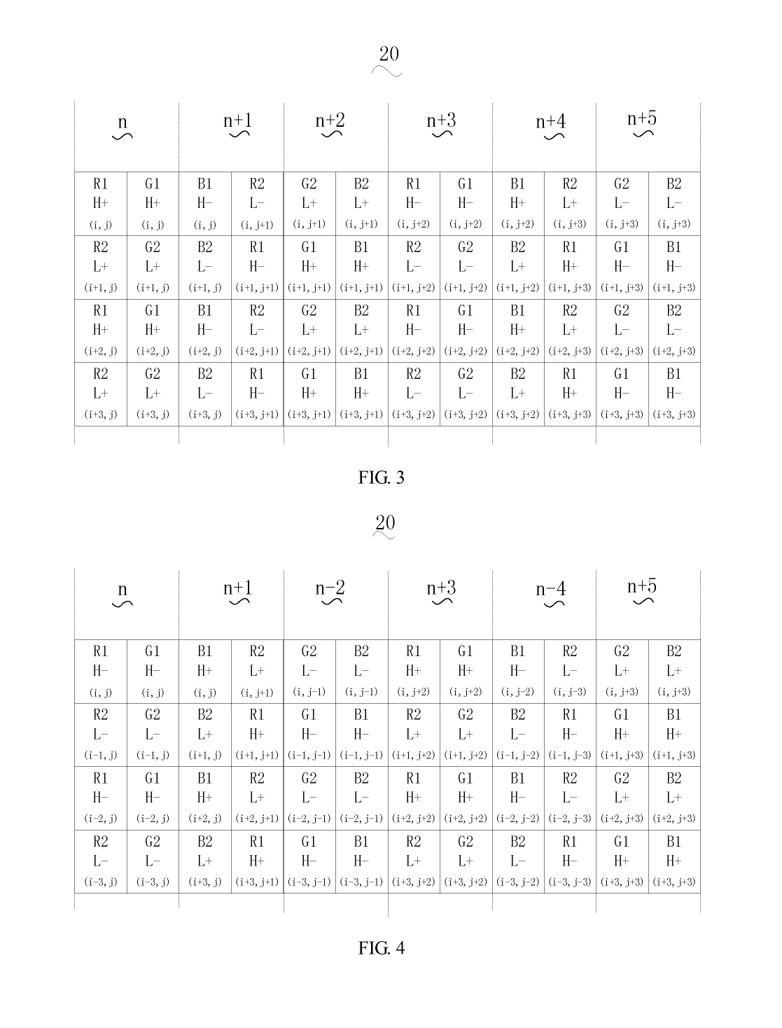

For example, as shown in FIG. 3, when twelve columns of sub-pixels in four rows of pixel units are taken as an example, the twelve columns of sub-pixels are divided into six sub-pixel groups named from nth to (n+5)th, and each sub-pixel group includes adjacent two columns of sub-pixels. R1, G1 and B1 respectively represent a red sub-pixel, a green sub-pixel and a blue sub-pixel in the first pixel unit. R2, G2 and B2 respectively represent a red sub-pixel, a green sub-pixel and a blue sub-pixel in the second pixel unit. H represents a first voltage level, L represents a second voltage level, + represents positive polarity, − represents negative polarity. (i, j) represents ith row jth column, (i, j+1) represents ith row (j+1)th column, (i+1, j) represents (i+1)th row jth column, and so on.

Column and row in the embodiment of the disclosure represent two kinds of arrangement directions mutually perpendicular to each other. For example, column represents a vertical direction, and row represents a horizontal direction; for another example, column represents a horizontal direction, and row represents a vertical direction. That is, “column” in the embodiment of the disclosure may be “row” as understood by those skilled in the art, and “row” in the embodiment of the disclosure may also be “column” as understood by those skilled in the art.

In an illustrated embodiment, two sub-pixels arranged in a same row in a same sub-pixel group may be sub-pixels of a same pixel unit, or may be sub-pixels of different pixel units. For example, the R sub-pixel and the G sub-pixel arranged in a same row in the nth sub-pixel group belong to a same pixel unit, the B sub-pixel and R sub-pixel arranged in a same row in the (n+1)th sub-pixel group belong to adjacent two pixel units respectively.

Specifically, for any two adjacent sub-pixel groups, the sub-pixels in one sub-pixel group are applied with drive voltages of positive polarity, the sub-pixels in the other one sub-pixel group are applied with drive voltages of negative polarity, and a drive voltage level of each sub-pixel is determined according to the pixel unit which the sub-pixel belongs to. For example, drive voltage levels corresponding to the first pixel unit and the second pixel unit are respectively preseted; or, a first voltage level corresponding to the first pixel unit and a second voltage level corresponding to the second pixel unit are preseted. The step S202 includes: using first drive voltages of opposite polarities to drive the sub-pixels of the first pixie unit respectively located in different sub-pixel groups, and using second drive voltages of opposite polarities to drive the sub-pixels of the second pixie unit respectively located in different sub-pixel groups. A voltage level of the first drive voltages is a preset first voltage level, and a voltage level of the second drive voltages is a preset second voltage level. Moreover, first drive voltages of opposite polarities are used to drive sub-pixels of the first pixel unit respectively located in different sub-pixel groups, and more specifically, the first drive voltage of positive polarity and the first drive voltage of negative polarity are used to drive the sub-pixels of the first pixel unit respectively located in different sub-pixel groups.

Second drive voltages of opposite polarities are used to drive sub-pixels of the second pixel unit respectively located in different sub-pixel groups, and more specifically, the second drive voltage of positive polarity and the second drive voltage of negative polarity are used to drive the sub-pixels of the second pixel unit respectively located in different sub-pixel groups.

For the first voltage level and the second voltage level, one is a high voltage level, and the other one is a low voltage level. For example, the first voltage level is higher than the second voltage level, or the first voltage level is lower than the second voltage level. In an illustrated embodiment, the positive polarity refers to the drive voltage is greater than a preset common voltage Vcom of the display panel, i.e., a voltage difference of the drive voltage relative to the voltage Vcom is greater than zero. The negative polarity refers to the drive voltage is lower than the voltage Vcom, i.e., a voltage difference of the drive voltage relative to the voltage Vcom is smaller than zero.

For example, as shown in FIG. 3, each sub-pixel in the nth sub-pixel group, the (n+2)th sub-pixel group and the (n+4)th sub-pixel group is applied with a drive voltage of positive polarity, each sub-pixel in the (n+1)th sub-pixel group, the (n+3)th sub-pixel group and the (n+5)th sub-pixel group is applied with a drive voltage of negative polarity, the drive voltage level of each sub-pixel belonging to the first pixel unit is high (H), and the drive voltage level of each sub-pixel belonging to the second pixel unit is low (L). As such, in each row, the number/amount of the sub-pixels applied with drive voltages of positive high voltage level (H+) is equal to the number of the sub-pixels applied with drive voltages of negative high voltage level (H−). For example, in each row of FIG. 3, the number of the sub-pixels with the positive high voltage level (H+) and the number of the sub-pixels with the negative high voltage level (H−) each are three. The number of the sub-pixels with the positive high voltage level and the number of the sub-pixels with the negative high voltage level being equal can make the voltage Vcom be prevented from the impact of parasitic capacitance, so that the correctness of image signal is ensured and the color shift or abnormal image quality would be suppressed.

In an embodiment, taking in account that adjacent sub-pixels in a same column having different drive voltage polarities would cause the voltage signal outputted from a same data line to frequently jump between high and low voltages, which not only leads to fever of data driver chip, but also leads to insufficient pixel charging caused by voltage signal distortion resulting from the influence of load on the display panel. In order to address the issue, in an illustrated embodiment, the driving method further includes: in a display period of each image frame, using drive voltages of a same polarity to drive sub-pixels in a same sub-pixel groups. That is, in a display period of a same image frame, the sub-pixels in a same sub-pixel group are applied with drive voltage of a same polarity. As such, it makes that drive voltages of each adjacent two rows of sub-pixels in a same sub-pixel group have a same polarity but different voltage levels. In a display period of any one image frame, multiple sub-pixels belong to a same sub-pixel group are applied with drive voltages of a same polarity, the drive voltages of the sub-pixels belonging to a same sub-pixel group and belonging to adjacent two pixel units have a same polarity but different voltage levels, and the drive voltages of the sub-pixels belonging to a same sub-pixel group and belonging to a same pixel unit have a same polarity and a same voltage level. Since the sub-pixels in a same column have a same drive voltage polarity, differences among multiple voltage signals outputted from a same data line are kept in a small range, which can avoid fever of the data driver chip or the voltage signal distortion and thereby improve display quality of the sub-pixels.

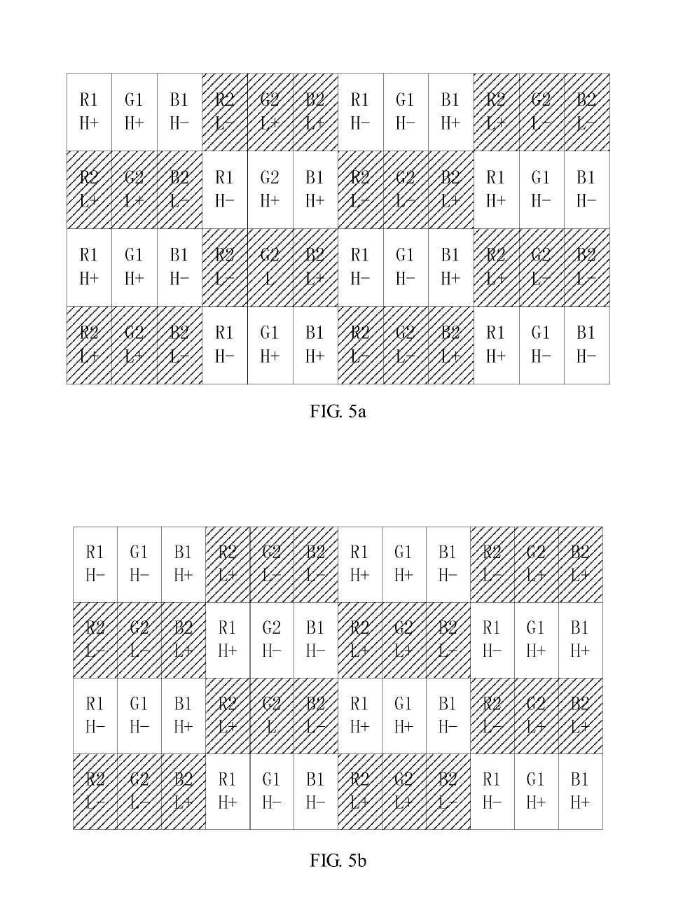

In an embodiment, when the display panel is a liquid crystal display panel, taking in account that a direct current (DC) electric field drives liquid crystal pixels, which would easily cause a chemical reaction of liquid crystal materials and accelerate the aging of electrodes and thereby shorten the lifespan of the display panel, and therefore in order to protect the liquid crystal materials and the electrodes and extend the lifespan of the display panel, an illustrated embodiment drives sub-pixels of the display panel in an alternating current (AC) manner. In particular, for a same sub-pixel, in display periods of each adjacent two image frames, drive voltages with different polarities are applied thereto to achieve an AC driving effect. For example, the driving method further includes: in each adjacent two frame display periods, drive voltages of opposite polarities are used to drive a same sub-pixel; or for each sub-pixel, a drive voltage applied thereto in each frame display period has a polarity opposite to a polarity of the drive voltage applied thereto in the previous frame display period. For example, in an mth frame display period, some sub-pixels of the display panel employ the drive voltages as shown in FIG. 3; and in an (m+1)th frame display period, the some sub-pixels of the display panel employ the drive voltages as shown in FIG. 4. As such, in each adjacent two frame display periods, the drive voltage polarity for a same sub-pixel is changed while the drive voltage level is kept unchanged.

As an embodiment, during driving the display panel, for each sub-pixel, its drive voltage polarity is determined according to the sub-pixel group which the sub-pixel belongs to, its drive voltage level is determined according to the pixel unit which the sub-pixel belongs to, and then its drive voltage is obtained according to an image data of the sub-pixel and corresponding drive voltage polarity and drive voltage level. The obtained drive voltage is applied to the sub-pixel through a data line.

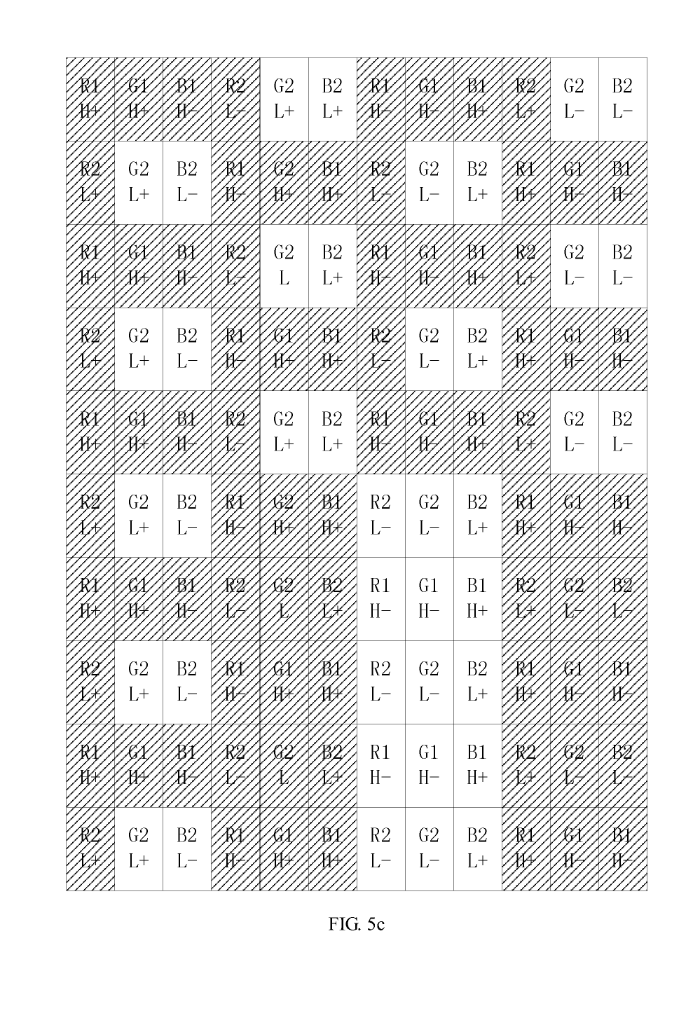

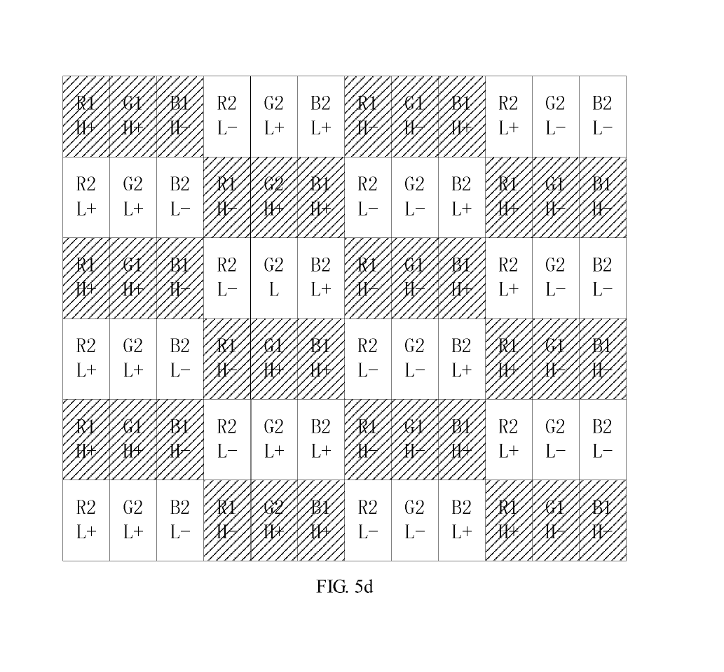

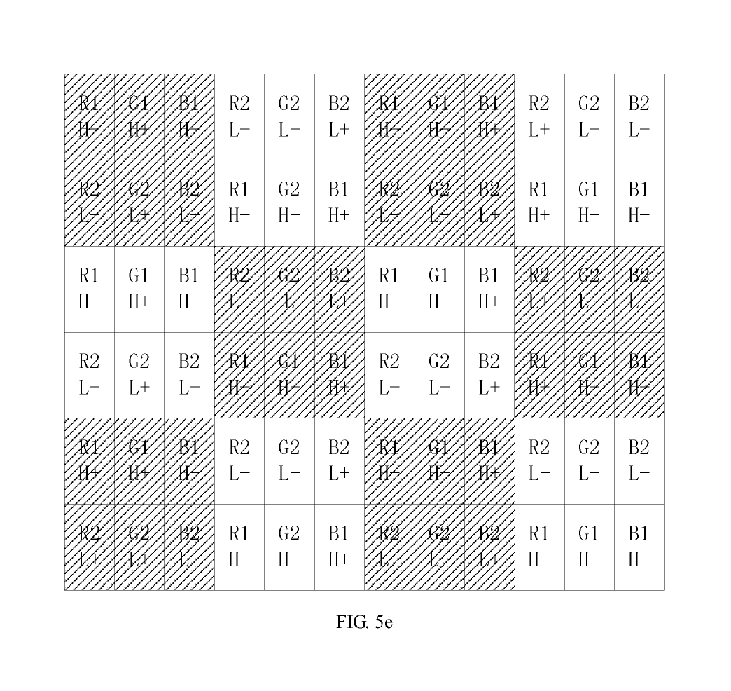

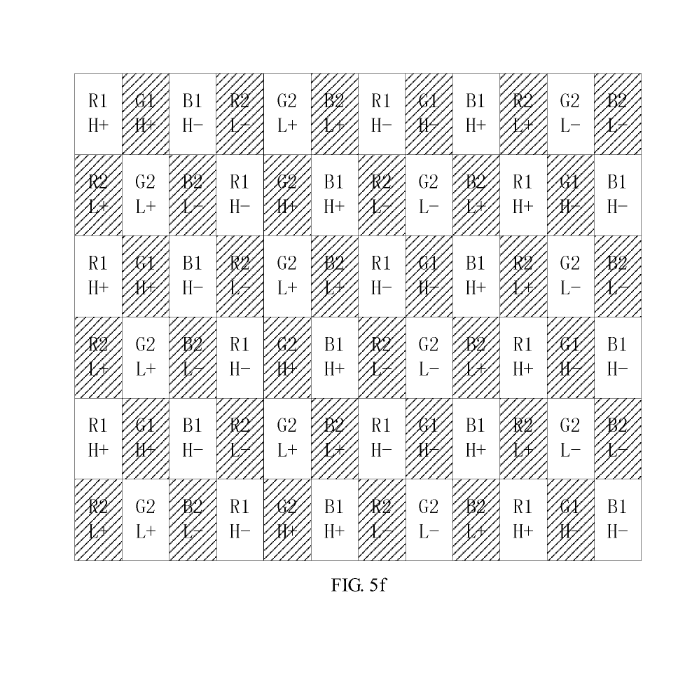

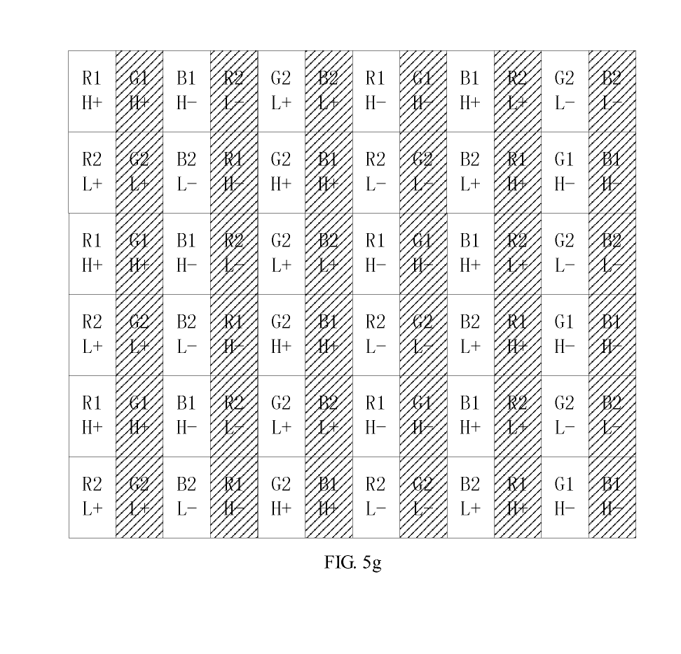

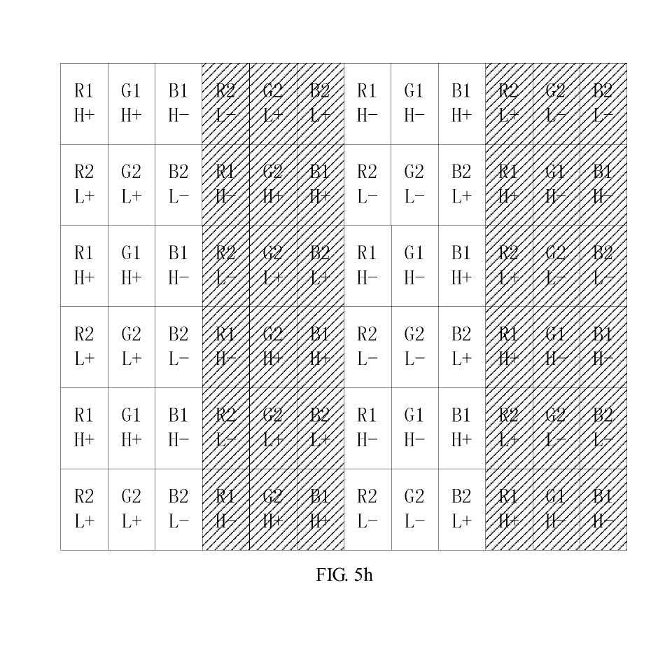

As the above driving method of a display panel is adopted, the display panel is driven to display several particular testing images as shown in FIG. 5a, FIG. 5b, FIG. 5c, FIG. 5d, FIG. 5e, FIG. 5f, FIG. 5g and FIG. 5h. Each sub-pixel filled with diagonal black lines represents that a data signal corresponding to the sub-pixel is a dark-state signal. Base on experiments, it has been found that displays of flicker images in FIG. 5a and FIG. 5b through an image in FIG. 5h have no color shift issue, the image in FIG. 5c can avoid crosstalk in horizontal direction, and the image in FIG. 5d has no color shift issue. FIG. 5d represents a bright and dark alternately displayed image by taking every one pixel unit as a unit, FIG. 5e represents a bright and dark alternately displayed image by taking every two pixel units as a unit, FIG. 5f represents a bright and dark alternately displayed image by taking every one sub-pixel as a unit, FIG. 5g represents a bright and dark alternately displayed image by taking every one column of sub-pixels as a unit, and FIG. 5h represents a bright and dark alternately displayed image by taking every one column of pixel units as a unit. Accordingly, the driving method of a display panel according to the embodiment of the disclosure has good color shift improving effect.

An embodiment of the disclosure provides a driving apparatus of a display panel. The driving apparatus of a display panel is applied to a display panel, for example the driving apparatus of a display panel is configured for driving the display panel. The display panel has multiple pixel units arranged in an array. The multiple pixel units include several first pixel units and several second pixel units. The first pixel units and the second pixel units are adjacently disposed, and each pixel unit includes multiple sub-pixels.

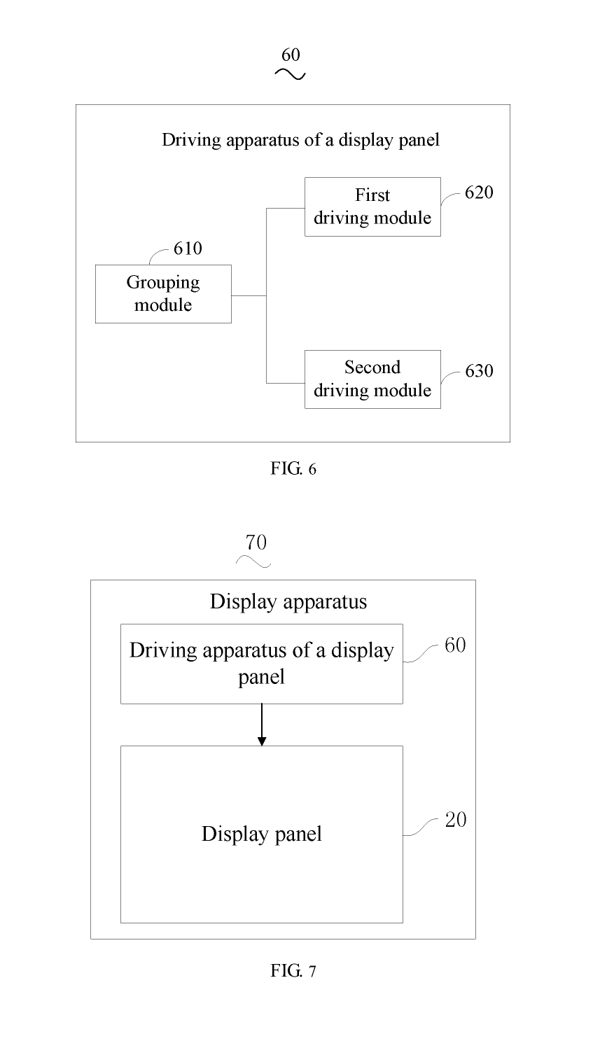

Referring to FIG. 6, the driving apparatus 60 of a display panel includes a grouping module 610, a first driving module 620 and a second driving module 630. The grouping module is configured for dividing multiple sub-pixels of the display panel into several sub-pixel groups to make each of the sub-pixel groups include adjacent two columns of sub-pixels. The first driving module 620 is configured for using drive voltages of opposite polarities to drive sub-pixels in each adjacent two of the sub-pixel groups. The second driving module 630 is configured for using drive voltages of different voltage levels to respectively drive each sub-pixel of a first pixel unit and each sub-pixel of a second pixel unit. As such, in each row, the number of sub-pixels applied with drive voltages of positive high voltage level (H+) is equal to the number of sub-pixels applied with drive voltages of negative high voltage level (H−), so that the voltage Vcom is prevented from the impact of parasitic capacitance and thereby correctness of image signal is ensured and the occurrence of color shift or abnormal image quality is avoided.

In an embodiment, the driving apparatus further includes a third driving module. The third driving module is configured for using drive voltages of opposite polarities to drive a same sub-pixel, in each adjacent two frame display periods. As such, it can make the sub-pixels be driven in AC driving manner, so as to protect liquid crystal materials and electrodes and thereby extend the lifespan of the display panel.

In an embodiment, the driving apparatus further includes a fourth driving module. The fourth driving module is configured for using drive voltages of a same polarity to drive sub-pixels in a same sub-pixel group, in each frame display period. As such, it can ensure that the sub-pixels in a same column have a same drive voltage polarity, so that differences among multiple voltage signals outputted a same data line are maintained in a small range, so as to avoid fever of data driver chip or voltage signal distortion and thereby improve display quality of sub-pixels.

In an embodiment, the second driving module 630 includes a first driving unit and a second driving unit. The first driving unit is configured for using first drive voltages of opposite polarities to drive sub-pixels of the first pixel unit respectively located in different sub-pixel groups. The second driving unit is configured for using second drive voltages of opposite polarities to drive sub-pixels of the second pixel unit respectively located in different sub-pixel groups. A voltage level of the first drive voltages is a preset first voltage level, and a voltage level of the second drive voltages is a preset second voltage level. As such, it can ensure that each adjacent two pixel units have high and low different drive voltage levels, and the sub-pixels in each adjacent two sub-pixel groups have opposite drive voltage polarities.

Still another embodiment of the disclosure provides a driving apparatus of a display panel, and the driving apparatus adopts the driving method of a display panel in any one of above embodiments. For example, a driving apparatus of a display panel is implemented by the driving method of a display panel in any one of above embodiments, or, a driving apparatus of a display panel has function modules corresponding to the driving method of a display panel in any one of above embodiments.

The driving method and driving apparatus of a display panel as provided by the disclosure can be applied into a liquid crystal display panel, an OLED (Organic Light-Emitting Diode) display panel, a QLED (Quantum Dot Light Emitting Diodes) display panel, a curved display panel or a flexible display panel, and so on. Moreover, when the liquid crystal display panel is taken for an example, it can be a TN (Twisted Nematic) liquid crystal display panel, an IPS (In-Plane Switching) liquid crystal display panel, a PLS (Plane to Line Switching) liquid crystal display panel, or a MVA (Multi-domain Vertical Alignment) liquid crystal display panel, and so on. The above display panel may be driven by a logic board of a full high-definition (FHD) display panel. That is, the above driving method and driving apparatus of a display panel may be embodied by the logic board of the full high-definition display panel.

The disclosure further provides a display apparatus. As shown in FIG. 7 the display apparatus 70 includes a display panel 20 and the driving apparatus 60 of a display panel in any one of the above embodiments.

For example, the display apparatus is a liquid crystal display apparatus, an OLED display apparatus, a QLED display apparatus, a curved display apparatus, or a flexible display apparatus, etc. Moreover, when the liquid crystal display apparatus is taken as an example, it can be a TN liquid crystal display apparatus, an IPS liquid crystal display apparatus, a PLS liquid crystal display apparatus, or a MVA liquid crystal display apparatus, and so on.

In the several embodiments provided by the disclosure, it should be understood that the described systems, devices and/or methods can be realized in other ways. For example, the embodiments of devices described above are merely illustrative. For example, division of units is only a logical functional division, and other division manner may be adopted in actual implementation, for example multiple units or components can be combined together or integrated into another system, or some features can be omitted or not implemented. In addition, the coupling or direct coupling or communication connection shown or discussed may be indirect coupling or communication connection through some interfaces, devices or units, which may be electrical, mechanical or otherwise.

The units described as separation parts may or may not be physically separated, and the parts shown as units may or may not be physical units, i.e., may be located in one place or distributed over multiple network units. Some or all of the units can be selected according to actual needs to achieve the purpose of the embodiments of the disclosure.

Finally, it should be noted that the above embodiments are merely illustrative of technical solutions of the disclosure and are not intended to be limiting thereof. Although the disclosure is described in detail with reference to the foregoing embodiments, a person skilled in the art should be understood that the technical solutions described in the foregoing embodiments can be modified or some of technical features can be equivalently replaced, and these modifications or replacements do not depart from the spirit and scope of the technical solutions of various embodiments of the disclosure.

What is claimed is:

1. A driving method of a display panel, comprising:
dividing a plurality of sub-pixels of a display panel into a plurality of sub-pixel groups, wherein each of the sub-pixel groups comprises adjacent two columns of the sub-pixels;
using drive voltages of opposite polarities to drive the sub-pixels in each adjacent two of the sub-pixel groups; and
using drive voltages of different voltage levels to drive the sub-pixels of a first pixel unit and the sub-pixels of a second pixel unit;
wherein the first pixel unit and the second pixel unit are adjacently disposed in the display panel.

2. The driving method of a display panel as claimed in claim 1, further comprising:
in each adjacent two frame display periods, using drive voltages of opposite polarities to drive a same sub-pixel.

3. The driving method of a display panel as claimed in claim 2, wherein the step of using drive voltages of different voltage levels to drive the sub-pixels of a first pixel unit and the sub-pixels of a second pixel unit comprises:
using first drive voltages of opposite polarities to drive the sub-pixels of the first pixel unit respectively located in different sub-pixel groups;
using second drive voltages of opposite polarities to drive the sub-pixels of the second pixel unit respectively located in different sub-pixel groups;
wherein a voltage level of the first drive voltages is a preset first voltage level, and a voltage level of the second drive voltages is a preset second voltage level.

4. The driving method of a display panel as claimed in claim 3, wherein the step of using first drive voltages of opposite polarities to drive the sub-pixels of the first pixel unit respectively located in different sub-pixel groups comprises:
using the first drive voltage of positive polarity and the first drive voltage of negative polarity to respectively drive the sub-pixels of the first pixel unit respectively located in different sub-pixel groups;
wherein the step of using second drive voltages of opposite polarities to drive the sub-pixels of the second pixel unit respectively located in different sub-pixel groups comprises:
using the second drive voltage of positive polarity and the second drive voltage of negative polarity to respectively drive the sub-pixels of the second pixel unit respectively located in different sub-pixel groups.

5. The driving method of a display panel as claimed in claim 2, further comprising:
in each frame display period, using drive voltages of a same polarity to drive the sub-pixels in a same sub-pixel group.

6. The driving method of a display panel as claimed in claim 5, wherein the step of using drive voltages of different voltage levels to drive the sub-pixels of a first pixel unit and the sub-pixels of a second pixel unit comprises:
using first drive voltages of opposite polarities to drive the sub-pixels of the first pixel unit respectively located in different sub-pixel groups;
using second drive voltages of opposite polarities to drive the sub-pixels of the second pixel unit respectively located in different sub-pixel groups;
wherein a voltage level of the first drive voltages is a preset first voltage level, and a voltage level of the second drive voltages is a preset second voltage level.

7. The driving method of a display panel as claimed in claim 6, wherein the step of using first drive voltages of opposite polarities to drive the sub-pixels of the first pixel unit respectively located in different sub-pixel groups comprises:
using the first drive voltage of positive polarity and the first drive voltage of negative polarity to respectively drive the sub-pixels of the first pixel unit respectively located in different sub-pixel groups;
wherein the step of using second drive voltages of opposite polarities to drive the sub-pixels of the second pixel unit respectively located in different sub-pixel groups comprises:
using the second drive voltage of positive polarity and the second drive voltage of negative polarity to respectively drive the sub-pixels of the second pixel unit respectively located in different sub-pixel groups.

8. The driving method of a display panel as claimed in claim 1, wherein the step of using drive voltages of different voltage levels to drive the sub-pixels of a first pixel unit and the sub-pixels of a second pixel unit comprises:
using first drive voltages of opposite polarities to drive the sub-pixels of the first pixel unit respectively located in different sub-pixel groups;
using second drive voltages of opposite polarities to drive the sub-pixels of the second pixel unit respectively located in different sub-pixel groups;
wherein a voltage level of the first drive voltages is a preset first voltage level, and a voltage level of the second drive voltages is a preset second voltage level.

9. The driving method of a display panel as claimed in claim 8, wherein the step of using first drive voltages of opposite polarities to drive the sub-pixels of the first pixel unit respectively located in different sub-pixel groups comprises:
using the first drive voltage of positive polarity and the first drive voltage of negative polarity to respectively drive the sub-pixels of the first pixel unit respectively located in different sub-pixel groups;
wherein the step of using second drive voltages of opposite polarities to drive the sub-pixels of the second pixel unit respectively located in different sub-pixel groups comprises:
using the second drive voltage of positive polarity and the second drive voltage of negative polarity to respectively drive the sub-pixels of the second pixel unit respectively located in different sub-pixel groups.

10. A driving apparatus of a display panel, comprising:
a grouping module, configured to divide a plurality of sub-pixels of a display panel into a plurality of sub-pixel groups, wherein each of the sub-pixel groups comprises adjacent two columns of the sub-pixels;
a first driving module, configured to use drive voltages of opposite polarities to drive the sub-pixels in each adjacent two of the sub-pixel groups; and
a second driving module, configured to use drive voltages of different voltage levels to drive the sub-pixels of a first pixel unit and the sub-pixels of a second pixel unit;
wherein the first pixel unit and the second pixel unit are adjacently disposed in the display panel.

11. The driving apparatus as claimed in claim 10, wherein the second driving module comprises:
a first driving unit, configured to use first drive voltages of opposite polarities to drive the sub-pixels of the first pixel unit respectively located in different sub-pixel groups;
a second driving unit, configured to use second drive voltages of opposite polarities to drive the sub-pixels of the second pixel unit respectively located in different sub-pixel groups;
wherein a voltage level of the first drive voltages is a preset first voltage level, and a voltage level of the second drive voltages is a preset second voltage level.

12. The driving apparatus as claimed in claim 10, further comprising:
a third driving module, configured to use drive voltages of opposite polarities to drive a same sub-pixel, in each adjacent two frame display periods.

13. The driving apparatus as claimed in claim 12, wherein the second driving module comprises:
a first driving unit, configured to use first drive voltages of opposite polarities to drive the sub-pixels of the first pixel unit respectively located in different sub-pixel groups;
a second driving unit, configured to use second drive voltages of opposite polarities to drive the sub-pixels of the second pixel unit respectively located in different sub-pixel groups;
wherein a voltage level of the first drive voltages is a preset first voltage level, and a voltage level of the second drive voltages is a preset second voltage level.

14. The driving apparatus as claimed in claim 12, further comprising:
a fourth driving module, configured to use drive voltages of a same polarity to drive the sub-pixels in a same sub-pixel group, in each frame display period.

15. The driving apparatus as claimed in claim 14, wherein the second driving module comprises:
a first driving unit, configured to use first drive voltages of opposite polarities to drive the sub-pixels of the first pixel unit respectively located in different sub-pixel groups;
a second driving unit, configured to use second drive voltages of opposite polarities to drive the sub-pixels of the second pixel unit respectively located in different sub-pixel groups;
wherein a voltage level of the first drive voltages is a preset first voltage level, and a voltage level of the second drive voltages is a preset second voltage level.

16. A display apparatus comprising a display panel and a driving apparatus of the display panel; wherein the driving apparatus comprises:
a grouping module, configured to divide a plurality of sub-pixels of the display panel into a plurality of sub-pixel groups, wherein each of the sub-pixel groups comprises adjacent two columns of sub-pixels;
a first driving module, configured to use drive voltages of opposite polarities to drive the sub-pixels in each adjacent two of the sub-pixel groups; and
a second driving module, configured to use drive voltages of different voltage levels to drive the sub-pixels of a first pixel unit and the sub-pixels of a second pixel unit;
wherein the first pixel unit and the second pixel unit are adjacently disposed in the display panel.

17. The display apparatus as claimed in claim 16, wherein the second driving module comprises:
a first driving unit, configured to use first drive voltages of opposite polarities to drive the sub-pixels of the first pixel unit respectively located in different sub-pixel groups;
a second driving unit, configured to use second drive voltages of opposite polarities to drive the sub-pixels of the second pixel unit respectively located in different sub-pixel groups;
wherein a voltage level of the first drive voltages is a preset first voltage level, and a voltage level of the second drive voltages is a preset second voltage level.

18. The display apparatus as claimed in claim 16, wherein the driving apparatus further comprises:
a third driving module, configured to use drive voltages of opposite polarities to drive a same sub-pixel, in each adjacent two frame display periods.

19. The display apparatus as claimed in claim 18, wherein the driving apparatus further comprises:
a fourth driving module, configured to use drive voltages of a same polarity to drive the sub-pixels in a same sub-pixel group, in each frame display period.

20. The display apparatus as claimed in claim 19, wherein the second driving module comprises:
a first driving unit, configured to use first drive voltages of opposite polarities to drive the sub-pixels of the first pixel unit respectively located in different sub-pixel groups;
a second driving unit, configured to use second drive voltages of opposite polarities to drive the sub-pixels of the second pixel unit respectively located in different sub-pixel groups;
wherein a voltage level of the first drive voltages is a preset first voltage level, and a voltage level of the second drive voltages is a preset second voltage level.
